(19) United States
(12) Patent Application Publication
(10) Pub. No.: US 2005/0018797 A1
(43) Pub. Date: Jan. 27, 2005

(54) Signal processing method

(75) Inventor: Ming-Hsiung Lin, Taipei (TW)

Correspondence Address: BRUCE H. TROXELL, SUITE 1404, 5205 LEESBURG PIKE, FALLS CHURCH, VA, 22041, US

(73) Assignee: Extra Communication Tech. Co., Ltd.

(21) Appl. No.: 10/721,286

(22) Filed: Nov. 26, 2003

(30) Foreign Application Priority Data
Jul. 25, 2003 (TW) 92120319

(51) Int. Cl. H04L 7/00

(52) U.S. Cl. 375/355

(57) ABSTRACT

The invention is to provide a signal processing method, which converts conventional data transmission method of using frequency slicing into a data transmission method of using the characteristics of a carrying function. In the invention, the data amount carried at one time is decided by the number of the base functions of the carrying function.

### FIELD OF THE INVENTION

The invention relates to a signal processing method, and in particular to a signal processing method that converts a method of data transmission using frequency into one using a carrying function.

### BACKGROUND OF THE INVENTION

In recent years, accompanying the progress of wireless communication technology, various digital mobile products, such as cellular phone, notebook computer, and PDA, have realized human wishes of wireless communication. By the new technology, not only people may get rid of bondage of traditional telephone wires, but also users are more free to be closer between each other.

However, since the frequencies available in the space are quite specific, and in consideration of nearby interference and the influence of side wave band, such that the practically available frequency is much limited. So, for data transmitting, bandwidth is a very valuable resource.

In tradition, there are four major ways for increasing the signal amount transmitted within the same bandwidth. The first one is to slice a larger bandwidth into several different bandwidths of smaller range, then plural signals are respectively modulated into different bandwidth ranges to be transmitted simultaneously. For example, the broadcasting signals of traditional TV and radio stations are processed by such way. However, since the amount of channel available to be sliced is limited due to the interference and technical problems, so such method apparently can not solve the problem of insufficient bandwidth. The second one is to apply time slicing in the same transmission frequency; that is, after the plural signals being respectively sliced into small packages, they are transmitted with the same frequency but in different times, then each package is combined to resume to the original form at the signal receiving terminal. For example, signal transmission of traditional network applies such technique. However, this kind of technique apparently will lower down the transmission efficiency greatly. Once the amount of signal desired to transmit is over a certain level, a phenomenon of “network jam” will happen at once. The third one is a combination of the above first and second methods. The fourth one is the OFDM method, which utilizes sampling function or quasi-sampling function. In this method, after the functions being respectively moved by different time units along the time axis, the formed function group has almost orthogonal characteristics. This function group is served as the base functions of the carrying function, which is integrated between [0, T+ε] (wherein T is the largest time moving in the base functions), then the carried data can be analyzed out respectively. However, there are three shortcomings in this method: (1) since the base functions are only almost orthogonal, so there will be errors generated when demodulating, and the more the base functions are, the larger the error is; (2) the least phase difference of each base function can not be too small, otherwise the base functions can not be almost orthogonal; particularly, when the base functions become more, T will become larger, such that time period of decoding and integrating will not be very small, and this means that the time needed to transmit data will be increased; (3) in fact, the bandwidth needed by the sampling function or the quasi one is still very large, so the function of saving bandwidth is very limited.

Thus, ROC Pat. No. 117049 (Pat. Application No. 87113934, Published No. 393847, which is abbreviated as Case 049 in the following) disclosed a mixing and separating method for multiple signals and device thereof, wherein the bandwidth won't be changed due to variation of the signals. This patent utilizes the separable characteristic of a linearly independent signal to respectively take several samples (for example, n samples Sᵢ(tⱼ), j=1,2 . . . , n) from multiple signals (for example, m signals Sᵢ(t), i=1,2 , . . . m), and to form a single mixing signal SM(t) which is a summation of those taken samples multiplied by different linearly independent signals (for example, m×n different sinusoidal wave signals ᵢaⱼ(t)) for the usage of transmission (wherein

$$SM ( t ) = {\sum }_{i = 1}^{m} {S}_{i}^{O} ( t )$$

$${S}_{i}^{O} ( t ) = {\sum }_{j = 1}^{n} [ Si ( tj ) iaj ( t ) ] , i = 1 , 2 , … m ) ,$$

The single mixing signal will use only one bandwidth, which is decided by the maximum bandwidth of the chosen ᵢaⱼ(t), so that it is a freely controlled bandwidth (its bandwidth will not be influenced by the amount of multiple signals Sᵢ(t) desired to be transmitted), and the multiple signals are transmitted at the same time. So the harassment of prior arts can be completely solved.

ROC Pat. Application No. 091124915 (abbreviated as Case 915 in the following) is proposed according to the shortcomings of Case 915. Since the signals transmitted according to Case 915 may have the following shortcomings: (1) there will be occurrence of discontinuous breaking points; (2) when there are too many signals to be transmitted, they will be interfered or unable to separate easily because the difference between each frequency is too small; (3) since simultaneous equations are applied to process the separation procedure for the mixing signals, the operational time is longer and the production cost is higher. So, Case 915 has not only the mixing signal SM(t), but also adds discontinuous point removing signal sin(pw₀t) and synchronous signal sin(qw₀t), both of which contain the basic angular frequency w₀, for generating a new signal for transmission, and the mixing signal can be expressed as the following:
SMS(t)=Sin(pwₒt)×SM(t)+Sin(qwₒt)

Since the synchronous signal is combined into the mixing signal to be transmitted simultaneously rather than sectionally, so not only the entire time section period can all be utilized for the transmission of information signal, but also the signal will lower down to zero at each time section to show a continuous state without any breaking point. And, the synchronous signal can be separated correctly at the signal receiving terminal. In addition, the frequency range for choosing the linearly independent signals

$${}_{i} {a}_{j} ( t ) is {A}_{i} \frac{{T}_{1}}{v} Hz ∼ ( {A}_{i} \frac{{T}_{1}}{v} + \frac{{T}_{1}}{2 v} ) Hz ,$$

such that there are appropriately spaced intervals remained between each of linearly independent signals ᵢaⱼ(t) and, following the rise of frequency, the interval range will be increased as well to further facilitates the easiness for signal processing.

However, Case 915 and Case 049 both have the same limitation of bandwidth. For example, in the bandwidth between 50-2000 Hz, 50 Hz is taken as an interval to avoid interference; that is, there are 400 channels such at 50, 100, 150, 200, . . . , 2000 Hz being utilized for transmitting data simultaneously. However, only 400 data can be transmitted at the same time, such that a bandwidth of 1950 Hz can carry

$$\frac{400}{2} \times \frac{1}{T} = \frac{200}{T}$$

signals (T is a time section). Of course, the efficiency can be increased by reducing the interval, but the interference between each adjacent wave channel when reducing the interval must be considered, so it is necessary to add circuits for processing interference. And, it is usually that the shorter the interval is, the more complicated the processing circuit will be, so the cost will be greatly increased exponentially. Thus, it is very uneconomical to increase the efficiency by adding the very high cost for shortening the interval.

Besides, when Case 915 is applied practically, the problem of poor detection for the synchronous signals will occur. Since there are many passive elements used in the practical circuits, such as resistance, capacitance, and inductance, etc., which contains great error range of 5-30%, the accumulative error will be even greater by the multiplication effect. So, in Case 915, the synchronous signals received at the receiving terminal will generate large phase difference and the phase difference can be expressed as Sin(qwₒt+θ). So, θ value must be evaluated before the practice for offsetting the inference of phase displacement, such that the accuracy can be controlled. However, since the variable factors of error are too many, it is difficult to completely control the synchronous signal; therefore, its practicability is very limited.

### SUMMARY OF THE INVENTION

The main objective of the invention is to provide a signal processing method for solving the problem of transmission bandwidth.

The secondary objective of the invention is to provide a signal processing method for overcoming the problem of signal synchronism.

For achieving the above objectives, the invention provides a signal processing method, which comprises the following steps:
sampling a data signal and the total sampling number is m, wherein each sample obtains a quantization value expressed as bᵢ, i=1 . . . m;
choosing a carrying function, wherein further comprising the following steps:
choosing plural base functions, each of which satisfies:
a. being one of even function or odd function;
b. being a continuous function;
c. being a periodic function, which period is T;
d. being orthogonal with other base functions;
wherein each base function g(n, t) can be expressed as a form of

$$h ( \frac{nT}{k} t ) ,$$
wherein
   h representing a function form,
   k representing the total number of the plural base functions,
   n representing the n-th base function,
   t representing the time variable;
choosing a frequency function f(t), which frequency is f;
using the plural base functions and the frequency function to generate the carrying function, which can be expressed as:

$$F ( n , t ) = \frac{T}{k} {\sum }_{i = 1}^{k} [ f ( t + \frac{T}{k} i ) g ( n , \frac{T}{k} i ) ]$$
encoding the sampled data signal by the carrying function to obtain a transmission signal, which frequency is f and can be expressed as:

$$SM ( t ) = {\sum }_{i = 1}^{n} {b}_{i} F ( i , t ) .$$

### BRIEF DESCRIPTION OF THE DRAWINGS

FIG. 1 is a flowchart of the invention.

FIG. 2A is an encoding block diagram of a preferable embodiment according to the invention.

FIG. 2B is a decoding block diagram of a preferable embodiment according to the invention.

### DETAILED DESCRIPTION OF THE INVENTION

For better recognizing and understanding the characteristics, objectives, and functions of the invention, a detailed description together with accompanying diagrams are presented as follows.

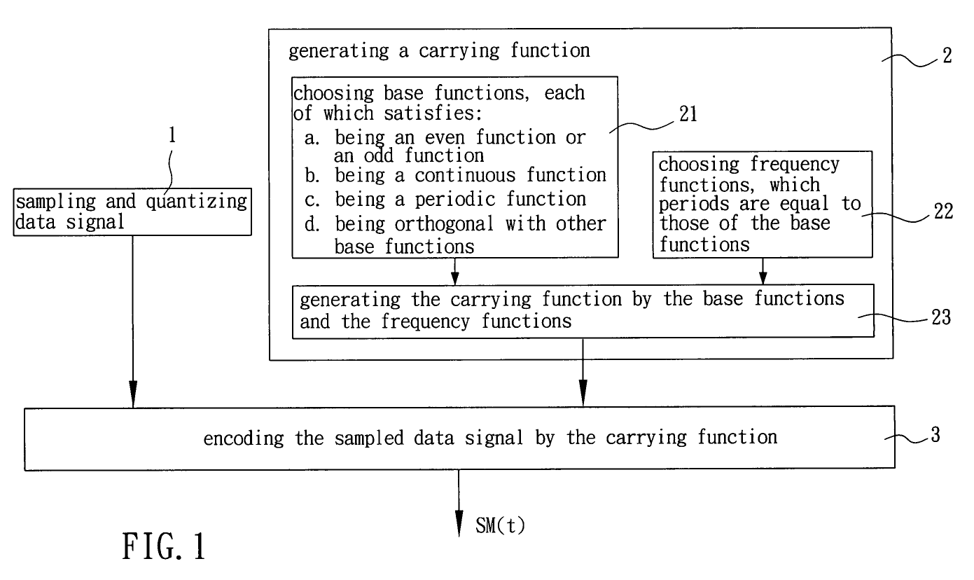

Please refer to FIG. 1, which is a flowchart according to the invention. The major spirit of the invention is to utilize plural orthogonal functions for carrying data instead of slicing frequency of conventional method for carrying data by different frequencies. The invention comprises the following steps:

Step 1: sampling a data signal. Since signals transmitted in digital form can reduce the error rate and can be more easily practiced in circuits, digital systems are adapted for most signal processing at the present. The invention samples a data signal and quantizes it, and the total sampling number is m, wherein each sampling can be expressed as bᵢ, i=1 . . . m. Of course, the number of samplings must fulfill the sampling theorem for avoiding of losing accuracy.

Step 2: by the following steps, generating a carrying function for carrying the data during transmission:
Step 21: choosing plural base functions, wherein each base function satisfies the following conditions:
   a. the base function must be an even function or an odd function;
   b. the base function must be a continuous function;
   c. the base function must be a periodic function, which period is T;
   d. the base function must be orthogonal with other base functions;

The reasons why these conditions are set will be further explained in detail in the decoding part thereinafter.

Each base function g(n, t) can be expressed as a form of

$$h ( \frac{nT}{k} t ) ,$$

where
h represents a function form, such as plural sine or cosine functions with different frequencies or their combinations
k represents the total number of the plural base functions,
n represents the n-th base function,
t represents the time variable.

Step 22: choosing a frequency function f(t) with period T, and which can be chosen at random, as long as the condition of period T is fulfilled, and the frequency range can be chosen freely, but it can not be one of the base functions.

Step 23: generating the carrying function by the plural base functions g(n, t) and the frequency function f(t), which can be expressed as:

$$F ( n , t ) = \frac{T}{k} {\sum }_{i = 1}^{k} [ f ( t + \frac{T}{k} i ) g ( n , \frac{T}{k} i ) ] ; \qquad ( 1 )$$

Step 3: encoding the sampled data signal by the carrying function to obtain a transmission signal SM(t), which is equal to each sampling point multiplied by its corresponding value of the carrying function, and which can be expressed as

$$SM ( t ) = {\sum }_{i = 1}^{n} {b}_{i} F ( i , t ) .$$

The frequency range of the transmission signal is decided by the frequency range of the frequency function. In an embodiment of the invention, the frequency range of transmission is the same as that of the frequency function; that is, the frequency range of transmission can be freely chosen by the designer. In another embodiment, the frequency function can be designated a specific frequency, e.g. 200 Hz. Thereby, a section of frequency range required by conventional transmission method can be compressed into a certain frequency only.

After the receiving terminal has received the transmission signal SM(t), a decoding process should be performed to obtain a sampled and quantized value of the data signal. The decoding method is to sum up every multiplication of each transmission signal and each base function, which can be expressed as:

$${b}_{n} = {c}_{n} {\sum }_{j = 1}^{k} [ SM ( t + \frac{T}{k} j ) g ( n , \frac{T}{k} j ) ] , n = 1 ⋯ k \qquad ( 2 )$$

wherein cₙ is a constant. And, from equation (1), it is known that SM(t) includes all components of the base functions and, according to the Euler-Maclaurin formula:

$$\begin{matrix}{\sum }_{s = 1}^{k} [ g ( i , \frac{T}{k} s ) g ( j , \frac{T}{k} s ) ] = {\int }_{0}^{T} g ( i , x ) g ( j , x ) ⅆ x - \\ \frac{1}{2} [ g ( i , T ) g ( j , T ) - g ( i , 0 ) g ( j , 0 ) ] + \\ {\sum }_{i = 1}^{∞} \frac{{B}_{2 s}}{( 2 s ) !} {( \frac{T}{m} )}^{2 i} [ {( g ( i , T ) g ( j , T ) )}^{( 2 s - 1 )} - \\ {( g ( i , 0 ) g ( j , 0 ) )}^{( 2 s - 1 )} ]\end{matrix}$$
wherein B₂ₛ is Bemeolli number. Since the base functions are all periodic functions with period T, g(i,T)=g(i,0),g(j,T)=g(j,0) in the second term of the above formula; i.e., the second term is zero. The third term is a so-called “multi-differentiated term”, which is also zero when the base functions are all odd functions or even functions of periodic functions with period T. Therefore, the original formula can be simplified as:

$${\sum }_{s = 1}^{k} [ g ( i , \frac{T}{k} s ) g ( j , \frac{T}{k} s ) ] = {\int }_{0}^{T} g ( i , x ) g ( j , x ) ⅆ x$$

Further, since each base function is an orthogonal function, ∫₀^{T}g(i, x)g(j, x)dx=Cᵢ when i=j
0 when i≠j (3)
wherein Cᵢ is a constant. So, except for the condition that the base function is multiplied by itself, the result will be zero when two different base functions are multiplied by each other. Therefore, the transmission signal is merely multiplied by its corresponding base function and divided by Ci during decoding process, then the sampling value of related data signal will be obtained. So, all the sampling values of the data signals will be obtained by sequentially multiplying the transmission signals with different base functions, such that the purpose of data transmission is achieved.

In an embodiment of the invention, if each base function is processed by a normalization, then equation (3) will becomes:
∫₀^{T}g(i, x)g(j, x)dx=1 when i=j
0 when i≠j

That is, it is unnecessary to be divided by Ci during the decoding process, so the decoding method can be simplified as:

$${b}_{n} = {\sum }_{j = 1}^{k} [ SM ( t + \frac{T}{k} j ) g ( n , \frac{T}{k} j ) ] , n = 1 ⋯ k$$

Therefore, it is possible to reduce the circuit design at the receiving terminal, such that the practicability of the invention is further enhanced.

In an embodiment, the transmitted signal has at least two periods and, according to the following equation:

$${b}_{n} = {\sum }_{j = 1}^{k} [ SM ( t + \frac{T}{k} j ) g ( n , \frac{T}{k} j ) ] , n = 1 ⋯ k$$

it is known that a period of information may be completely picked up at any point of t where the calculation is started, so the troublesome problem of the synchronous transmission of data signals can thereby be solved.

The main contribution of the invention is that the conventional method of data transmission by slicing frequency is successfully converted into one by the characteristics of carrying function for data transmission. That is, the technical difficulty is converted from the frequency interval into the number of base functions, so that the search for base functions becomes very important. From the aforementioned descriptions, it can be well known that there are four restrictions for the base functions: (a) the base functions must be even functions or odd functions; (b) the base functions must be continuous functions; (c) the base functions must be periodic functions with period T; (d) the base functions must be orthogonal with each other. The conditions (a), (b), (c) can be satisfied easily, but condition (d) can be found by many methods. A well-known method is that, there are functions of h₁, h₂, h₃ . . . hₙ, and their mutually orthogonal functions H₁, H₂, H₃ . . . Hₙ can be obtained according to the following method:

$${H}_{1} = {h}_{1}$$

$${H}_{2} = {α}_{21} {h}_{1} + {α}_{22} {h}_{2}$$

$${H}_{3} = {α}_{31} {h}_{1} + {α}_{32} {h}_{2} + {α}_{33} {h}_{3}$$

$$⋮$$

$${H}_{n} = {α}_{n1} {h}_{1} + {α}_{n2} {h}_{2} + {α}_{n3} {h}_{3} ⋯ + {α}_{nn} {h}_{n}$$

Although the calculations will be more complicated and it is more difficult to obtain the results when the latter steps are performed, it is possible to obtain infinite orthogonal functions in theory. In practical applications, base functions of the carrying function may be selected in advance and there is no need to choose base functions again at data transmission. In particular, memory devices such as ROM (read only memory), PROM (programmable read only memory), EPROM (erasable programmable read only memory), and EEPROM (electrically erasable programmable read only memory), etc. may be used for storing the base functions, which can be read out and used directly during data transmission, so that the objectives of the invention can be achieved.

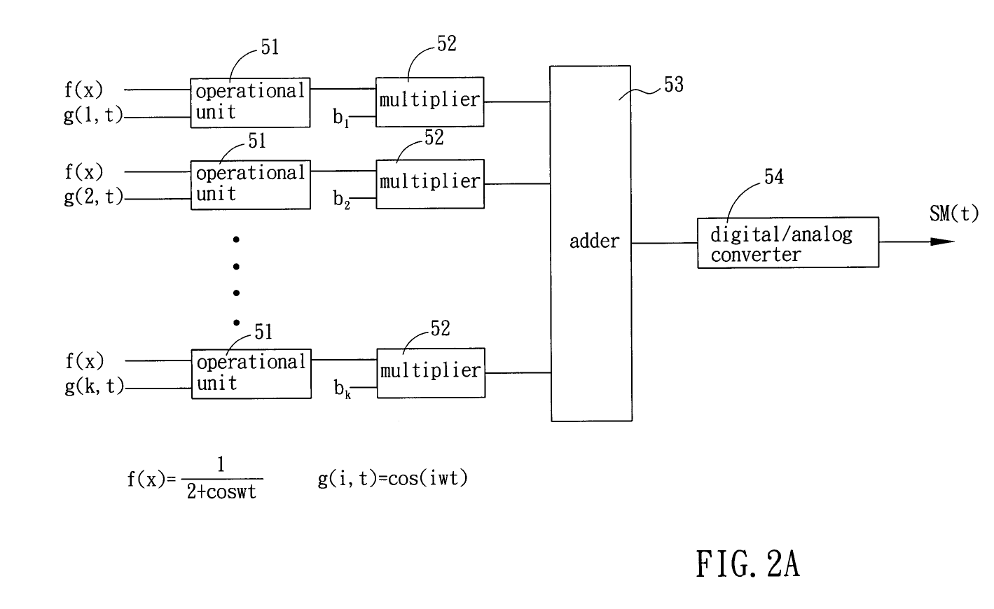

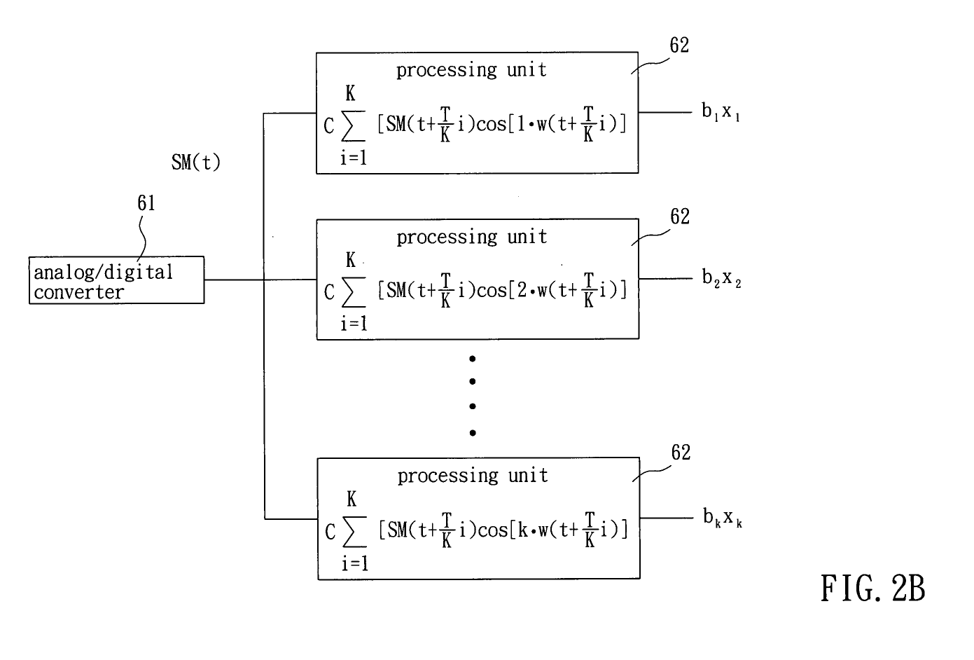

Please refer to FIG. 2, which is a block diagram of a preferable embodiment according to the invention. FIG. 2A shows the encoding part of the block diagram, wherein the base functions and the frequency functions of the invention can be obtained in advance and are stored in a memory device as stated above. In this embodiment of the invention, k operational units 51 are used to accomplish the calculation for

$$F ( n , t ) = \frac{T}{k} {\sum }_{i = 1}^{k} [ f ( t + \frac{T}{k} i ) g ( n , \frac{T}{k} i ) ] ,$$

wherein each operational unit 51 includes two inputs, one of which is frequency function, and the other one is i-th base function, i=1, . . . ,k. Then, k multipliers 52 and an adder 53 are used to calculate the value of

$$SM ( t ) = {\sum }_{i = 1}^{n} {b}_{i} F ( i , t ) .$$

Finally, a digital/analog (D/A) converter 54 is used to output the transmission signal SM(t). In a preferable embodiment of the invention, the frequency function may be chosen as

$$f ( t ) = \frac{1}{2 + cos ω t} ,$$

wherein

$$ω = \frac{2 π}{T}$$

and the base functions may be chosen as g(i,t)=cos(iωt).

Please refer to FIG. 2B, which shows the decoding part of the block diagram of the invention. In order to obtain bᵢ, i=1 . . . k, the transmission signal SM(t) is processed first by analog/digital (A/D) converter 61, then the processed signals are respectively input into k processing units 62, each of which makes an operation on the transmission signal with a specific base function and, finally b₁x₁, b₂x₂,b₃x₃, . . . bₖxₖ can be sequentially obtained, wherein, x₁, x₂, x₃, . . . xₖ are constants. Therefore, the data have to be divided by x₁, x₂, x₃, . . . xₖ respectively before operation so as to obtain the desired b₁, b₂, b₃, . . . bₖ. In another preferable embodiment of the invention, each base function has to be normalized, such that we can obtain x₁=x₂=x₃= . . . =xₖ=Y, wherein y is a constant. During operation, each processing unit can be directly divided by y to obtain the desired data for facilitating further convenience.

Finally, one thing is specially pointed out: in order to smoothly describe the characteristics of the invention, the invention is divided into Step 1, Step 2, and Step 3 in FIG. 1, wherein Step 2 is further divided into Step 21, Step 22, and Step 23. In fact, the sequence of Step 1 and Step 2 can be exchanged, and Step 21 and Step 22 can be exchanged as well. That is, when performing the invention, the data signal can be sampled first and the carrying function is then generated, or the carrying function can be generated first and the data signal is then sampled. Of course, Step 1 and Step 2 can be performed simultaneously. Similarly, when generating the carrying function, the base function can be chosen first and the frequency function is then chosen, or the frequency function is chosen first and the base function is then chosen, or both of Steps 21 and 22 can be performed simultaneously. Therefore, exchanging the sequence of Step 1, Step 2 and the sequence of Step 21, Step 22 is within the scope of the invention undoubtedly.

However, the aforementioned descriptions merely refer to several preferable embodiments of the invention and, of course, can not limit the scope of the invention. So, any equivalent variation and modification made according to the claims claimed in the invention is still within the field covered by the patent of the present invention without losing the essence thereof. Please your esteemed examining members examine the present application in a clear way and grant it as a formal patent as favorably as possible.

1. A signal processing method, comprises the following steps:
A. sampling a data signal to obtain a carrying function;
wherein a data signal is sampled and the total sampling number is m, and each sample obtains a quantization value expressed as bᵢ, i=1 . . . m;
wherein said carrying function can be obtained according to the following steps:
choosing plural base functions and a frequency function f(t);
wherein each base function satisfies the following conditions:
a. being an even function or an odd function;
b. being a continuous function;
c. being a periodic function, which period is T;
d. being orthogonal with other base functions;
wherein each base function g(n, t) can be expressed as a form of
$$h ( \frac{nT}{k} t ) :$$
h representing a function form,
k representing the total number of said plural base functions,
n representing the n-th base function,
t representing the time variable;
wherein bandwidth of said frequency function f(t) is fₙ and period of said frequency function f(t) is T;
using said plural base functions and said frequency function to generate said carrying function, which can be expressed as:
$$F ( n , t ) = \frac{T}{k} {\sum }_{i = 1}^{k} [ f ( t + \frac{T}{k} i ) g ( n , \frac{T}{k} i ) ]$$
B: encoding said sampled data signal by said carrying function to obtain a transmission signal, which bandwidth is fₙ and can be expressed as:
$$SM ( t ) = {\sum }_{i = 1}^{n} {b}_{i} F ( i , t ) .$$

2. The signal processing method according to claim 1, wherein a decoding method is to sum up every multiplication of each transmission signal and each base function for sequentially obtaining said data signal, which can be expressed as:
$${b}_{n} = {c}_{n} {\sum }_{j = 1}^{k} [ SM ( t + \frac{T}{k} j ) g ( n , \frac{T}{k} j ) ] , n = 1 … k$$
wherein cₙ is a constant.

3. The signal processing method according to claim 1, wherein said plural base functions are normalized functions.

4. The signal processing method according to claim 1, wherein said base functions are sine functions.

5. The signal processing method according to claim 1, wherein said base functions are cosine functions.

6. The signal processing method according to claim 1, wherein said base functions are combinations of sine functions and cosine functions.

7. The signal processing method according to claim 1, wherein said base functions can be calculated in advance and are stored in a memory device.

8. A signal processing method, comprises the following steps:
choosing plural base functions and a frequency function f(t),
wherein each base function satisfies the following conditions:
a. being an even function or an odd function;
b. being a continuous function;
c. being a periodic function, which period is T;
d. being orthogonal with other base functions;
each base function g(n,t) can be expressed as a form of
$$h ( \frac{nT}{k} t ) ,$$
wherein:
h representing a function form,
k representing the total number of said plural base functions,
n representing the n-th base function,
t representing the time variable;
wherein period of said frequency function f(t) is T;
using said plural base functions and said frequency function to generate said carrying function, which can be expressed as:
$$F ( n , t ) = \frac{T}{k} {\sum }_{i = 1}^{k} [ f ( t + \frac{T}{k} i ) g ( n , \frac{T}{k} i ) ]$$

9. The signal processing method according to claim 8, wherein a data signal is encoded by said carrying function to obtain a transmission signal, which can be expressed as:
$$SM ( t ) = {\sum }_{i = 1}^{n} {b}_{i} F ( i , t ) ,$$
wherein bᵢ, i=1 . . . m, is obtained by said data signal after sampling and quantization steps.

10. The signal processing method according to claim 9, wherein a decoding method is to sum up every multiplication of each transmission signal and each base function for sequentially obtaining said data signal, which can be expressed as:
$${b}_{n} = {c}_{n} {\sum }_{j = 1}^{k} [ SM ( t + \frac{T}{k} j ) g ( n , \frac{T}{k} j ) ] , n = 1 … k$$
wherein cₙ is a constant.

11. The signal processing method according to claim 8, wherein said plural base functions are normalized functions.

12. The signal processing method according to claim 8, wherein said base functions are sine functions.

13. The signal processing method according to claim 8, wherein said base functions are cosine functions.

14. The signal processing method according to claim 8, wherein said base functions are combinations of sine functions and cosine functions.

15. The signal processing method according to claim 8, wherein said base functions can be calculated in advance and are stored in a memory device.
